(19) United States
(12) Patent Application Publication
(10) Pub. No.: US 2009/0295104 A1
(43) Pub. Date: Dec. 3, 2009

(54) Adjustable Engraving Tool Holder

(76) Inventor: Raymond Anthony Cover, Festus, MO (US)

Correspondence Address: Michael Philip Artemis, 3450 Bowie Road, Reno, NV, 89503, US

(21) Appl. No.: 12/131,071

(22) Filed: May 31, 2008

(51) Int. Cl. B25G 3/26; B23P 11/00

(52) U.S. Cl. 279/83; 29/428; 29/592

(57) ABSTRACT

An engraving tool holder for use in delicate engraving operations that provides fine tool length adjustment. The holder further provides adjustment of tool retention pressure. The holder has a bore that extends axially from the rear of the holder toward the front. Within this bore is an adjusting member that establishes the insertion depth of a tool. The tool holder has a tool receiving aperture formed axially and extending from the forward end. The receiving aperture has a substantially similar cross-sectional shape as the tool inserted into the holder. The holder has at least one retention member located adjacent to the forward end and perpendicularly engages the tool along the receiving aperture.

### FIELD OF THE INVENTION

The present invention relates to the art of engraving. More particularly, the invention relates to an adjustable engraving tool holder having improved tool control with fine tool adjustment capability.

### BACKGROUND OF THE INVENTION

The art of engraving has been a distinguished field for centuries. Engraving is typically employed to embellish a vast array of objects. These objects can include jewelry, printing plates, watches, firearms and pocket knives to name a few. Additionally, engraving artwork is commonly found on various forms of currency.

Engraving artwork may take the form of intricate scroll and leaf designs, art-deco designs and a myriad of illustrations. The artwork may further include precious metal inlay, such as gold wire inlay, to intensify the engraving design. Bulino or Banknote style of engraving is another form of engraving that produces pictorial representations of diverse scenes. Engraving is typically executed by cutting designs upon a metal surface. The cuts appear as lines on the metal surface and when the engraving is complete, will resemble a drawing similar to a pen and ink illustration or possibly a photograph.

Engravers use a vast selection of engraving equipment. This equipment may include items such as chasing hammers, chisels, hand-held push engravers, awls, sharpening stones etc. In recent times the traditional hammer and chisel method of engraving has given way to modern engraving impact drivers. The modern engraving impact drivers commonly used are pneumatically actuated, small and hand-held. An example of such a modern engraving device can be found in U.S. Pat. No. 6,095,256 to Lindsay, the disclosure of which is hereby incorporated by reference. Use of such modern impact drivers reduces the need for an engraver to use both hands as previously required when using the hammer and chisel method. This permits the engraver to use the free hand for rotating the work piece and produces smoother curves such as those frequently found in scroll designs. Pneumatically powered engraving devices are well-suited for cutting many types of designs. The improvements in modern technology have made engraving an art form that is readily accessible to persons interested in learning the art of engraving.

In spite of these technological advances, the traditional hand-held push engraver is still extensively used for engraving the fine details of a pictorial scene such as Bulino or Banknote style. A traditional hand-held push engraver usually consists of an engraving tool inserted into a small palm-sized handle. The engraving tool is a hardened steel tool with an end specifically sharpened for cutting a metal surface. This engraving tool is commonly referred to in the engraving arts as a “graver” but may also be referred to as a cutting bit, burin, or tool tip. The handle is configured to fit adequately and comfortably in the engraver's hand. The handle also provides pressure distribution when forcing the graver along the metal surface.

A masterfully engraved piece of artwork will commonly use both a scroll and leaf design combined with a pictorial scene in Bulino or Banknote style. Scenes in Bulino or Banknote commonly range from wildlife scenes to portraiture. This style of engraving has recently become very popular and is in high demand among collectors and engraving enthusiasts. The pictorial representations in Bulino engravings are extremely lifelike and include very fine detail and shading similar to a fine portrait or actual photograph.

In cutting a Bulino design an engraver will typically use a pneumatically actuated hand piece in performing most of the engraving operations, such as outlining the various elements like scrolls and leaves; inlaying precious metals and applying background treatments. The engraver will then typically switch to a traditional hand-held push engraver to shade and enhance the engraving elements. The fine details and tonal qualities of these engravings are what breaths life into the design and increases the desirability of the artwork.

Obtaining the various tonal qualities requires very finely engraved cuts that, when viewed as a whole, are blended by the human eye into tones resulting in a visual perception of various shades of gray. In executing the cuts, an engraver commonly uses a magnification device and a traditional hand-held push engraver to do the very delicate cuts upon the metal surface. Some examples of commonly used magnification devices are surgical loupes, a jeweler's loupe or a stereo microscope. The cuts can be either minute dots or fine lines or a combination of both. The engraver arranges the dots or lines to obtain shading and texture to suit the particular design requirements. Bulino cuts are very repetitive and delicate. For example, the minute dots may number close to a hundred in an area approximately the size of a pin head.

When using the dot method, an engraver “picks” very small divots out of the metal surface. The engraver alters the spacing, depth and density of the dots to achieve the required tonal values on the metal surface. The engraver holds the hand-held push engraver in his hand and rapidly picks dots upon the engraved surface. In performing this process, a high frequency of cuts are made per minute and the graver typically requires frequent sharpening. Correspondingly, each time the graver is sharpened the length is decreased.

Alternatively, the shading may be executed using fine lines. This method of shading requires very fine lines excised upon the surface to achieve the various tonal values. The engraver may cut the fine lines in various ways to obtain different shades of gray. For example, the engraver may vary the spacing, offset or crosshatching of the cuts to develop various shadings as the design requires. The cuts are performed by very delicately pushing the graver along the engraved surface. This shading method requires very precise placement and control of the graver to obtain the tonal values.

One teaching of a traditional hand-held push engraver handle is found in U.S. Pat. No. 399,641 to Wundes, the disclosure of which is hereby incorporated by reference. The '641 patent teaches the use of a wooden handle that extends the major length of an engraving tool or graver, a sliding tapered sleeve for securing the graver into the handle and a recess for receiving a pre-bent noncutting end of the graver. This approach enables the graver to be placed into the wooden handle and provides comfort and ease of use during the engraving process. While useful, this disclosure requires that the graver have an end specifically adapted to fit the recess cavity. This tool handle also does not provide for adjusting the length of the graver as it decreases in length. Thus, an engraver will either have to modify the end of an engraving tool blank, which is time consuming, or purchase an engraving tool blank configured to fit this type of tool handle. In addition, when this type of tool handle is used in repetitive or high frequency cutting, the sliding tapered sleeve does not adequately secure the graver and the graver will frequently work loose.

Another teaching of a traditional hand-held push engraver handle is found in U.S. Pat. No. 429,223 also to Wundes, the disclosure of which is hereby incorporated by reference. The '223 patent teaches the use of a wooden handle that extends the major length of an engraving tool or graver, a sliding tapered sleeve for securing the graver and a toothed strip for receiving a specially configured end of the graver. This approach enables the graver to be placed into the wooden handle and, as the graver is sharpened, provides a coarse length adjustment. This approach, while useful, also requires that the graver have an end specifically adapted to fit the toothed strip. The specially configured end will either require additional time to fabricate or require the engraver to incur additional expense by purchasing special blanks. Furthermore, this style of engraving tool blank, with a specially adapted end, is presently less common as the engraving industry has standardized the use of a blank that is essentially straight and has a square cross-section with no specially configured ends. Likewise, when this type of tool handle is used in repetitive or high frequency cutting, the sliding sleeve does not retain sufficient tension between the graver, sliding sleeve and handle, and will frequently work loose.

Additionally, the teaching of U.S. Pat. No. 5,203,417 to Glasser, the disclosure of which is hereby incorporated by reference, provides a hand-held push engraver that uses interchangeable collets. These special collets are fitted with a graver. The special collet is then inserted into a handle for use in manual engraving. The collet/graver assembly can then be removed for sharpening. This modern attempt to provide a hand-held push engraver, while useful, requires an additional step of fitting the graver to the collet prior to insertion into the handle. Moreover, this configuration does not provide for an adequate length adjustment, which is necessary as the length of the graver decreases with repetitive sharpening. Also, this device requires the purchase of special proprietary collets for use in the handle.

Correspondingly, currently available hand-held push engraver handles still suffer from severe deficiencies in providing an adjustable, readily removable and precision graver handle and have not met with significant success to date.

### SUMMARY OF THE INVENTION

The present invention is an apparatus and method of fabricating an adjustable engraving tool holder enabling the engraver to adjust the insertion depth of an engraving tool and further providing for easy removal and reinsertion of the engraving tool.

In one embodiment, the invention comprises an engraving tool holder with a primary housing. The housing has a forward end, an aft end, a tool receiving aperture extending along the housing's longitudinal axis from the forward end toward the aft end, a tool position adjustment bore arranged substantially co-axial with respect to the receiving aperture and extending from the aft end toward the forward end, and a first retention cavity located adjacent to the forward end extending radially outward from the tool receiving aperture. The invention includes a tool position adjusting member operatively received in the tool position adjustment bore and arranged for motion along the longitudinal axis of the housing. A tool retention member is operatively received in the retention cavity and is arranged for radial motion within the cavity.

The engraving tool holder is preferably configured with the adjustment bore extending axially about ⅔ the length of the housing from the aft end and the receiving aperture extending axially about ⅓ the length of the housing from the forward end.

Preferably, the engraving tool holder includes an additional retention cavity located adjacent to the forward end and having an axis extending radially outward from the receiving aperture in a substantially perpendicular orientation with respect to the receiving aperture. The additional retention cavity may be offset along the longitudinal axis, angularly offset with respect to the first retention cavity or offset in both directions.

Additionally, the invention can be configured with the tool receiving aperture formed to substantially match an engraving tool cross-section to provided a close fit between the receiving aperture and the engraving tool. For example, with a standard square cross-sectional engraving tool the receiving aperture is essentially square.

The invention preferably further includes a handle having an axial cavity that receives a portion of the housing's aft end. In another embodiment, the engraving tool holder can be configured with a handle that is integrally formed with the housing.

The invention has different configurations with respect to the adjustment bore and adjusting member. In a preferred embodiment, the adjustment bore has internal threads formed therein, and an adjusting member has mating external threads for operative engagement with the internal threads of the bore. An alternative embodiment has an adjustment bore with an indexing surface internally formed along a portion of the bore, and an adjusting member with a spring-loaded protrusion for engaging the indexing surface.

The invention preferably includes a retention cavity that has internal threads formed therein and a retention member with mating external threads for operative engagement with the internal threads of the cavity. The retention member may be a commercially available ball plunger. The invention can alternatively have a retention cavity that is formed to substantially match a profile of a spring-bar. In this embodiment the spring-bar is adapted for insertion into the retention cavity.

From a broadest method aspect, the invention comprises fabricating an adjustable engraving tool holder, including the steps of:
(a) fabricating a housing having a forward end and an aft end;
(b) forming an axially aligned tool receiving aperture in the housing extending rearwardly from the forward end of the housing;
(c) forming an axially aligned tool position adjustment bore in the housing extending forwardly from the aft end of the housing; and
(d) forming a radially extending retention cavity in the housing adjacent to the forward end of the housing and terminating in and substantially perpendicular with the receiving aperture.

The invention can also include the steps of providing an adjusting member for insertion into the adjustment bore and a retention member for insertion into the retention cavity.

In another embodiment, the method further includes the step of providing a handle having an axial cavity and fabricating a housing that is adapted for insertion within the axial cavity. Additionally, the invention includes the steps of providing internal threads formed on the adjustment bore, and providing an adjusting member having mating external threads for engagement with the treads formed within the bore.

The invention enables various length engraving tools to be inserted into the engraving tool holder and the overall length of the assembly can be adjusted for consistent length. The adjustable engraving tool holder and engraving tool assembly, provides a tool that is comfortable, has superior tool control characteristics and enhances productivity. The invention further provides an engraving tool holder where the engraving tool is easily removed for sharpening and can be reinserted without the use of additional tools or excessive effort. This facilitates the engraving process by eliminating the need to loosen fasteners, assemble an engraving tool in to a special collet or dismantle the engraving tool holder to remove and sharpen the engraving tool.

For a fuller understanding of the nature and advantages of the present invention, reference should be made to the ensuing detailed description and claims, taken in conjunction with the accompanying drawings.

### BRIEF DESCRIPTION OF THE DRAWINGS

FIG. 1 is an isometric view of an adjustable engraving tool holder including an engraving tool as viewed from above;

FIG. 2 is an exploded isometric view of an adjustable engraving tool holder of FIG. 1 as viewed from above;

FIG. 3 is an elevation view of an adjustable engraving tool holder showing section lines A-A and B-B, as viewed from the top;

FIG. 4 is a sectional view taken along line A-A of FIG. 3 illustrating an adjustable engraving tool holder set to accommodate a full length engraving tool;

FIG. 5 is a sectional view taken along line A-A of FIG. 3 alternately illustrating an adjustable engraving tool holder set to accommodate a shortened engraving tool;

FIG. 6 is a section view taken along line B-B of FIG. 3 illustrating a retention member engaging an engraving tool;

FIG. 7A is an exploded isometric view for an alternate embodiment of the adjustable engraving tool holder, including detail sections D1 and D2, as viewed from above;

FIG. 7B is an enlarged exploded isometric view of detail area D1 of FIG. 7A illustrating an alternate embodiment for a retention member;

FIG. 7C is an enlarged exploded isometric view of detail area D2 of FIG. 7A illustrating an alternate embodiment for an adjusting member;

FIG. 8 is an elevation view for an alternate embodiment of the adjustable engraving tool holder, including section line C-C, as viewed from the top;

FIG. 9 is a section view taken along line C-C of FIG. 8, illustrating an alternate embodiment for an adjustable engraving tool holder.

FIG. 10 is an enlarged view of detail area D3 of FIG. 9 illustrating the interface between an indexing surface and an adjusting member;

FIG. 11 is an isometric view of an alternate embodiment showing a unitary construction for an adjustable engraving tool holder including an engraving tool as viewed from above; and

FIG. 12 is an isometric view of another alternate embodiment of the adjustable engraving tool holder including an engraving tool as viewed from above.

### DETAILED DESCRIPTION OF THE PREFERRED EMBODIMENTS

The invention is an adjustable engraving tool holder. In the following description, numerous specific details are set forth in order to provide a more thorough description of the present invention. It will be apparent, however, to one skilled in the art, that the present invention may be practiced without these specific details. In other instances, well-known features have been indicated although not described in detail so as not to obscure the invention.

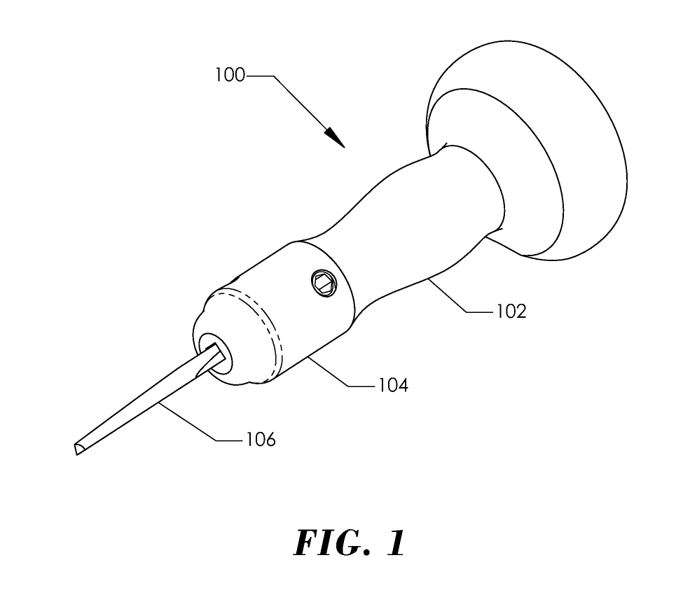

Referring to the figures, FIG. 1 illustrates an adjustable engraving tool holder 100 having a handle 102 contoured to comfortably fit in the palm of the hand. An engraving tool holder housing 104 is shown with a handle 102 mounted thereon. An engraving tool 106 is inserted into the housing 104. As used herein, the term engraving tool indicates a cutting tool made of tempered steel with a point configured for excising a surface. Such an engraving tool is commonly referred to in the art as a “graver.”

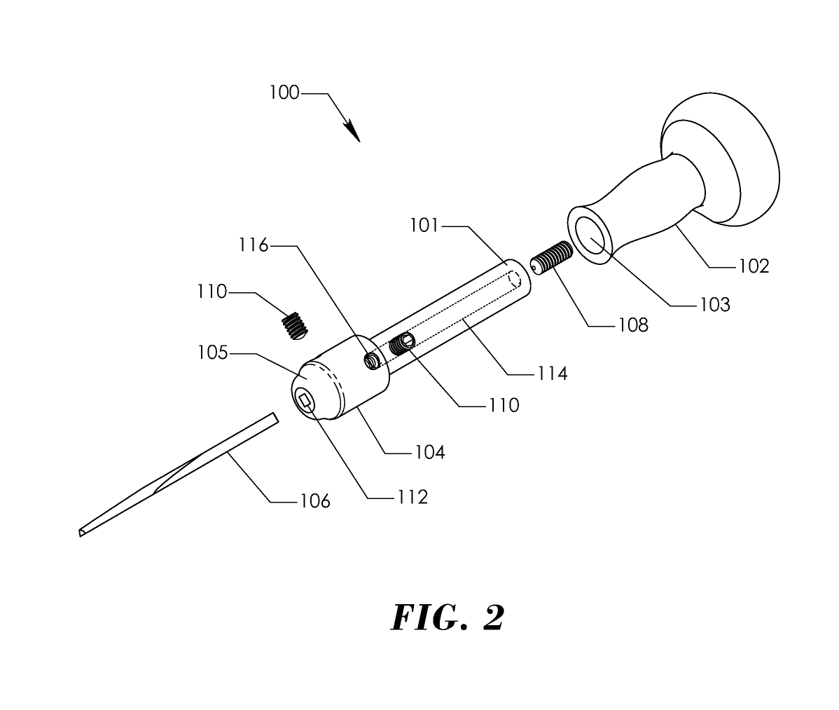

FIG. 2 illustrates an exploded isometric view of the engraving tool holder 100. Handle 102 has an axial cavity 103 adapted for receiving a mating portion of housing 104. The housing 104 has a forward end 105 for receiving an engraving tool 106 and an aft end 101 for receiving an adjusting member 108. An example of an adjusting member 108 is a threaded set screw. The forward end 105 of housing 104 has a tool receiving aperture 112 adapted to closely fit the cross-sectional shape of an engraving tool 106. The aft end 101 of housing 104 is fitted with an axial tool position adjustment bore 114 for operatively receiving an insertion depth adjusting member 108. Retention members 110 are operatively received into radially extending retention cavities 116 adjacent to the forward end 105 of housing 104.

In a preferred embodiment, handle 102 is fabricated from material sufficiently suited for use in the hand. Examples of such materials are various hardwoods, polymer compounds, metals and resins. Housing 104 is machined, cast or otherwise formed such that the housing 104 provides adequate strength, support and engagement of an engraving tool 106, and further provides operative engagement for an insertion depth adjusting member 108 and retention member 110. One exemplary material for housing 104 is stainless steel. However, other suitable materials are aluminum, brass, carbon steel and polymer composites.

When components are manufactured, some amount of tolerance or dimensional deviation is present and is frequently required for the components to adequately fit together. It is common for the deviation between parts to produce what is termed “tolerance build-up.” Tolerance build-up is the accumulation of dimensional deviations and typically results in parts fitting either too tightly or too loosely. Correspondingly, it is envisioned that receiving aperture 112 may be sized to accept engraving tools 106 that are slightly larger than standard size and thus the receiving aperture will accept a wide range of engraving tools 106. Retention member 110 provides a means for removing excess tolerance when an engraving tool 106 is inserted into the engraving tool holder 100 but also permits effortless removal of the engraving tool 106 for sharpening.

Retention member 110 has several known structures that are commercially available. Some specific examples for retention member 110 are a set screw, a nylon tip set screw or a spring-loaded ball plunger. The retention member 110 preferably engages an edge or facet on the engraving tool 106. In a preferred embodiment retention members 110 are a spring-loaded device such as a ball plunger provided by M.J. Vail Company, of Hillsborough, N.J.

A ball plunger is a self-contained spring-loaded device that may act as either a detent mechanism or pre-load device for applying a set pressure to a mating surface. A ball plunger comprises a cylindrical outer surface with external threads formed thereon for operative insertion into a threaded bore. One end is formed to receive a mating tool for turning the body of the plunger. An axial cavity is formed opposite the tool receiving end. A spring is inserted into the axial cavity. A detent ball is then inserted into the cavity compressing the spring. The detent ball and spring are secured in place by rolling or crimping the edge of the axial cavity to capture the components as a complete spring loaded unit.

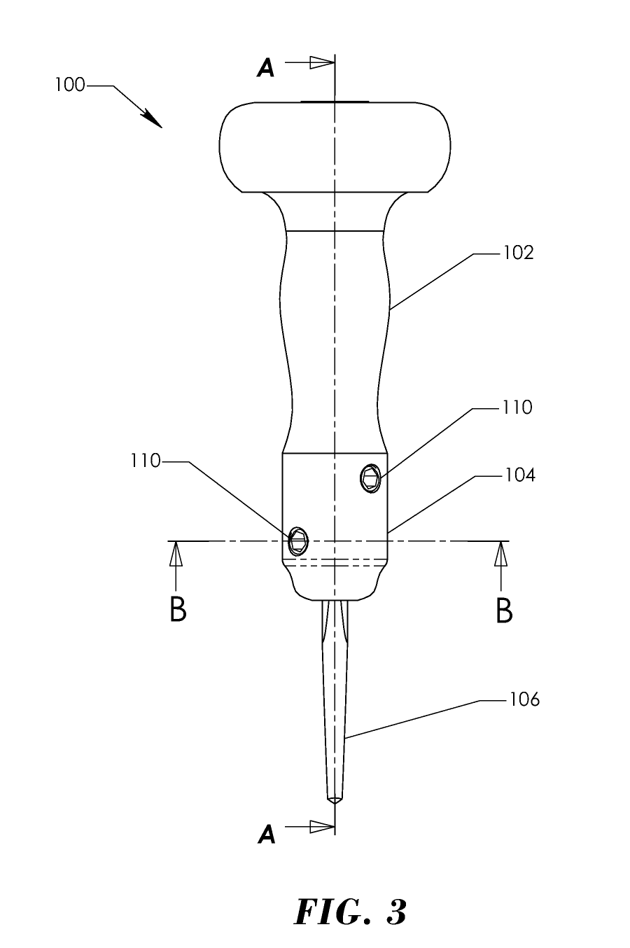

As illustrated in FIG. 3, the engraving tool holder 100 has retention members 110 arranged such that retention pressure is applied to an engraving tool 106. Pressure is applied to an engraving tool 106 to consume any tolerance build up between the receiving aperture 112 and engraving tool 106. Additionally, in a preferred embodiment the location and arrangement of retention members 110 are offset along the central longitudinal axis of the housing 104, angularly offset with respect to each other and adjacent to the engraving tool receiving end of housing 104. With this arrangement, radial deviations of the engraving tool 106 are minimized and the engraving tool holder 100 provides precise placement and control of the engraving tool 106.

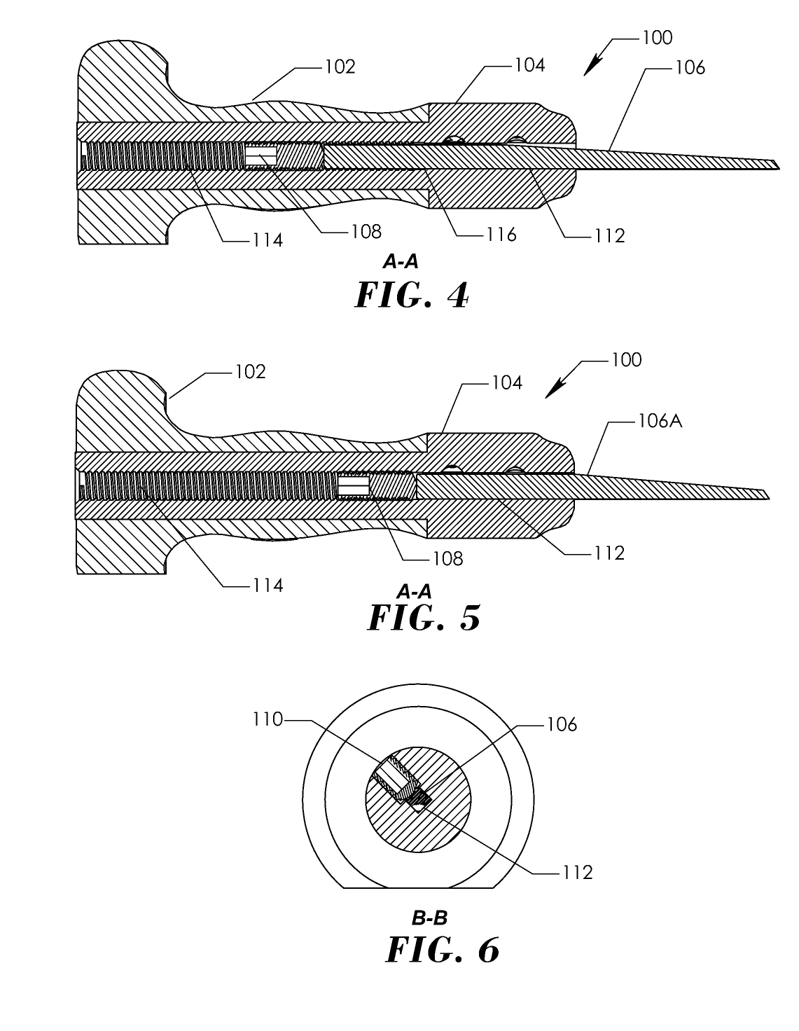

FIG. 4 is a sectional view taken along line A-A of FIG. 3, which illustrates a receiving aperture 112 extending from the forward end of housing 104 toward the adjustment bore 114. The receiving aperture 112 terminates at an axial junction 116 formed between the adjustment bore 114 and the receiving aperture 112. In one embodiment, the receiving aperture 112 extends a distance which ranges from about at least twice the thickness of an engraving tool 106 to about one-third the length of the housing 104. The receiving aperture 112 extends only moderately into the housing 104 and the receiving aperture 112 provides substantial bearing support for the engraving tool 106.

As best seen in FIG. 4, an engraving tool 106 can be mounted in the engraving tool holder 100 to form an assembled unit. The length of the assembled unit is adjusted by operating an insertion depth adjusting member 108 such that the overall length of the assembled unit properly fits an engraver's hand and satisfies the engraver's ergonomic preference.

In operation, the adjustment procedure is accomplished by inserting a tool into the axial adjustment bore 114, where the tool is operatively compatible with the insertion depth adjusting member 108, and actuating the insertion depth adjusting member 108 to a desired axial depth location within the housing 104. For example, with a socket-type adjusting member, an engraver would insert a mating socket-type driver into adjustment bore 114 and turn the adjusting member 108 either clockwise or counterclockwise until the desired insertion depth of the engraving tool 106 is achieved. Since the insertion depth adjusting member 108 is in contact with the end of the engraving tool 106, insertion depth adjustments made to adjusting member 108 will affect the overall combined length of the engraving tool holder 100 and the engraving tool 106 by axially moving both the adjusting member 108 and the engraving tool 106 in unison. Thus, the adjusting member 108 functions as a mechanical stop, in the axial direction, for the insertion depth of the engraving tool 106.

A typical engraving tool 106 decreases in length over time because each time the engraving tool 106 is sharpened, material is removed causing a reduction in overall length. The invention provides adjustability regarding the insertion depth of the engraving tool 106 into the housing 104 to compensate for the material removed during the sharpening process.

FIG. 5 illustrates a modified engraving tool 106A that is shorter in length than the previously illustrated engraving tool 106 shown in FIG. 4. Shortened engraving tool 106A is inserted into engraving tool holder 100 such that the overall length is comparable to an assembly using the longer engraving tool 106, as shown in FIG. 4. The overall length is adjusted by actuating the insertion depth adjusting member 108, as previously discussed.

Reference is now made to FIG. 6, which illustrates the interface between the receiving aperture 112, engraving tool 106 and a retention member 110. The receiving aperture 112 is broached such that it closely fits the cross-sectional contour of an engraving tool 106. Broaching is a manufacturing process that is well-known and therefore is not discussed in detail herein.

In a preferred embodiment, retention members 110 are adjusted to provide sufficient pressure on an engraving tool 106 such that the engraving tool 106 is adequately retained in the housing 104. The radially applied pressure from the retention member 110 reduces radial deviations and provides superior engraving tool control while excising material. Additionally, the amount of radially applied pressure preferably allows easy removal of the engraving tool 106 without the use of additional tools or excessive effort. In this way, engraving tool 106 is releasably retained in the housing 104 and is effortlessly removed for sharpening.

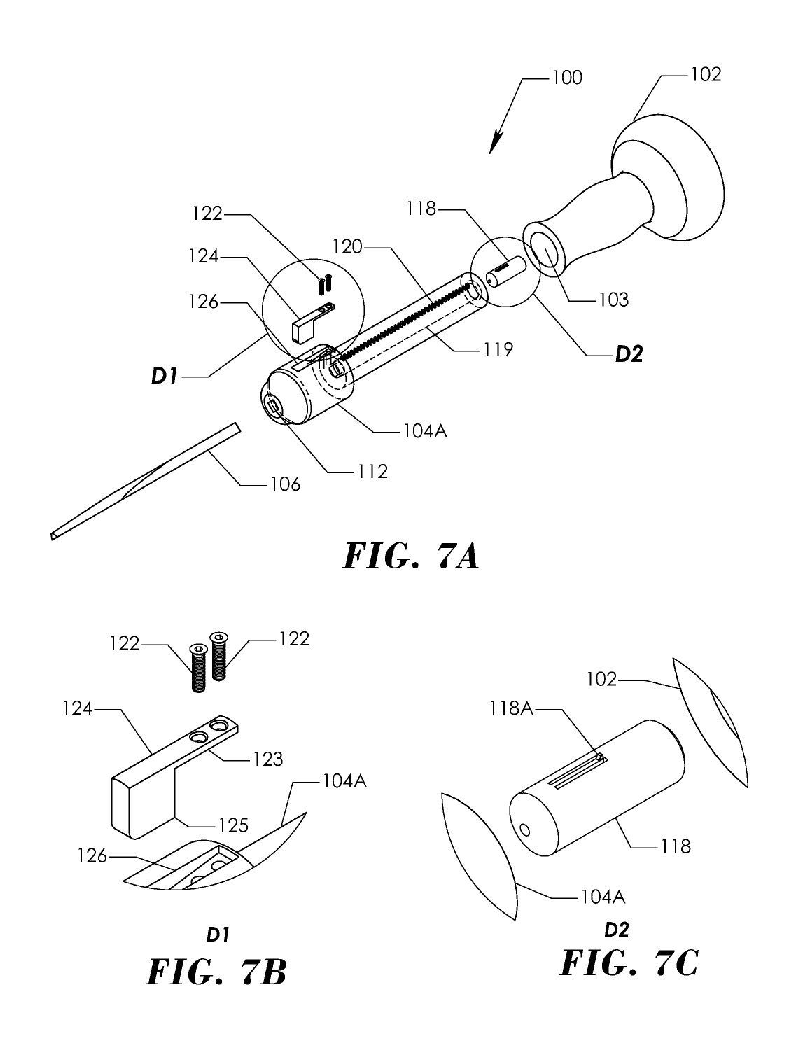

FIG. 7A illustrates an alternate embodiment of an adjustable engraving tool holder 100 having different configurations for the engraving tool retention member and insertion depth adjusting member. The components similar to the previously described embodiments are: handle 102, engraving tool 106 and receiving aperture 112. Housing 104A is modified to include an adjustment bore 119 with an indexing surface 120 formed thereon. The indexing surface 120 has a plurality of detents or recesses for accepting a mating protrusion. An adjusting member 118 is configured for receipt into adjustment bore 119 and engagement of indexing surface 120. Housing 104A further includes a spring bar 124 that is received into a spring bar retention cavity 126 and operatively retained by fastener members 122.

FIG. 7B is an enlarged detail illustration showing spring bar 124, spring bar retention cavity 126 and fastener members 122. Spring bar 124 has a protrusion 125 that extends into the retention cavity 126 and operatively engages an engraving tool 106. A spring arm 123 is provided and is preferably tempered to provide adequate spring force for retaining an engraving tool 106.

FIG. 7C is an enlarged detail view showing an adjusting member 118 that is fitted with a spring-loaded protrusion 118A that operatively engages the indexing surface 120 internally formed upon adjustment bore 119. The spring loaded protrusion 118A includes an integrally formed spring member as shown or alternately comprises a secondary spring member (not shown) that is operatively inserted into the adjusting member 118.

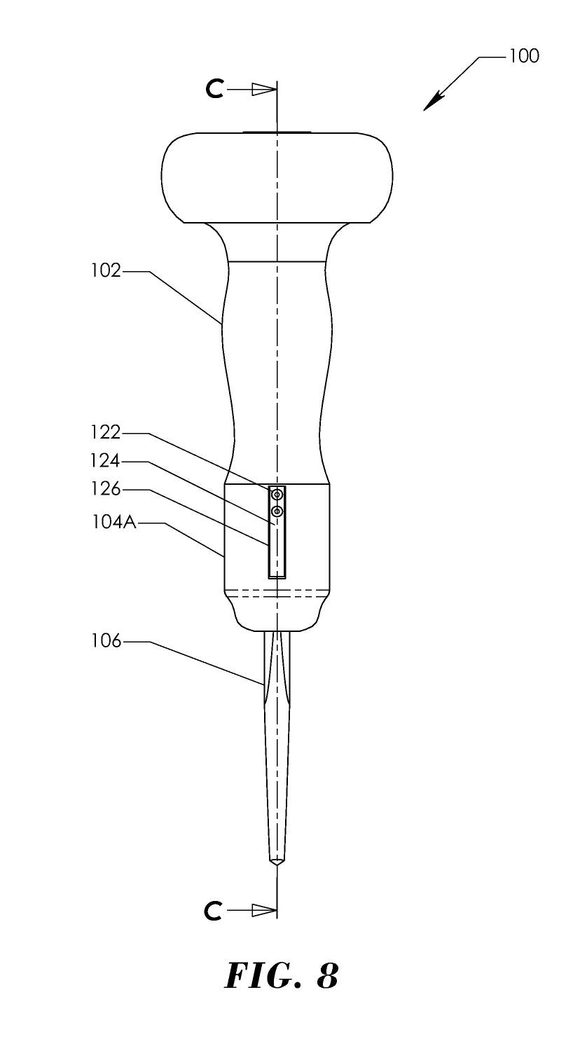

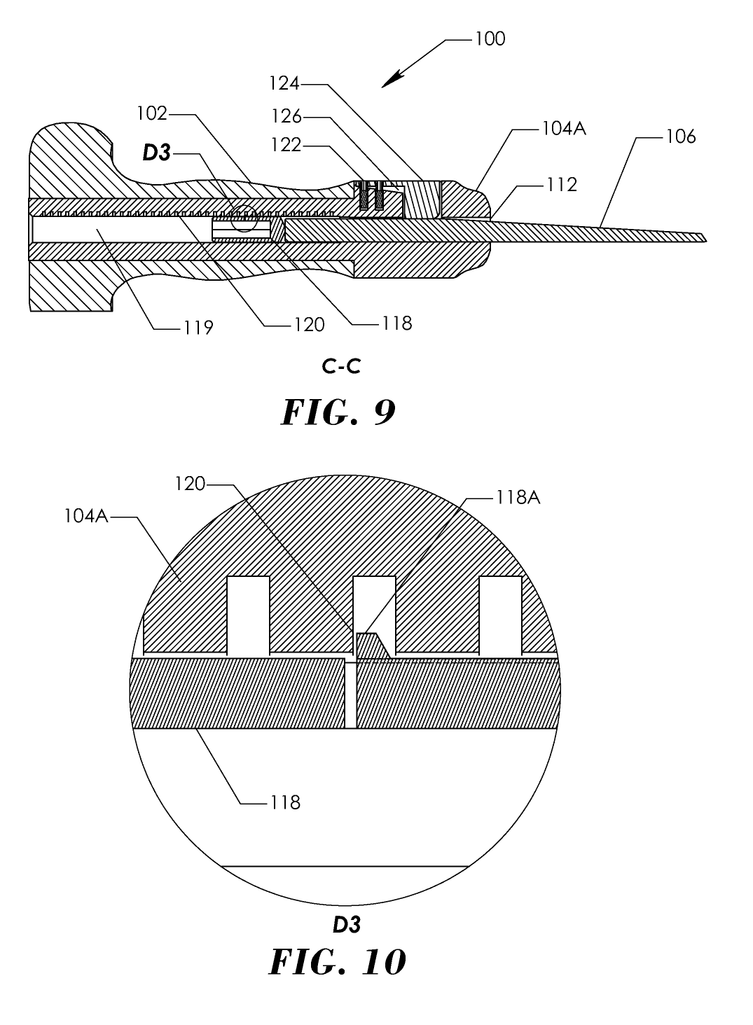

Turning to FIG. 8, the spring bar 124 is aligned with the central longitudinal axis of engraving tool holder 100 and located adjacent to the forward end of housing 104A. Spring bar 124 preferably engages the engraving tool 106 in a substantially perpendicular orientation and is retained by fastener members 122.

As best seen in FIG. 9, an engraving tool 106 is inserted into the receiving aperture 112 as previously discussed. Adjusting member 118 provides a mechanical stop that establishes the insertion depth of the engraving tool 106. The insertion depth is adjusted by inserting a tool configured to operatively engage the adjusting member 118 and advancing the adjusting member to the desired depth. Indexing surface 120 provides a plurality of regions where the spring-loaded protrusion 118A operatively engages the indexing surface 120. The engagement provides a mechanical latch that prevents rearward displacement of the adjusting member 118 once the desired depth is adjusted. The axial insertion depth of engraving tool 106 is limited by the location of adjusting member 118 within the adjustment bore 119.

Turning to FIG. 10, which is an enlarged detail view showing an adjusting member 118, and the interaction between the spring-loaded protrusion 118A of the adjusting member and indexing surface 120. In operation, when the adjusting member 118 is advanced, the spring-loaded protrusion 118A radially extends to engage the mating regions of the indexing surface 120 formed on the adjustment bore. The interface between the spring-loaded protrusion 118A and the recesses of indexing surface 120 provide a secure latch that prevents the adjusting member 118 from rearward displacement while the engraving tool is being used to excise material.

The adjusting member 118 may be returned to a rearward position by using a compatible tool and turning the adjusting member 118 such that spring-loaded protrusion 118A is disengaged from the indexing surface 120. The adjusting member 118 is then pushed rearward with the inserted engraving tool 106. Once the adjusting member 118 is at the desired rearward position, the adjusting member is then rotated such that the spring-loaded protrusion 118A engages the indexing surface 120. The adjusting member 118 can then be advanced forward as necessary.

In this alternate embodiment, the spring bar 124 provides retention pressure for consuming the tolerance build up between the receiving aperture 112 and the engraving tool 106. The spring bar 124 preferably engages the engraving tool 106 opposite an engraving tool edge or facet. The amount of pressure imparted from the spring bar 124 to the engraving tool 106 is adjusted by actuating spring bar fastener members 122 and increasing or decreasing the spring pre-load on spring bar 124. The retention pressure is preferably established so the engraving tool is adequately supported while cutting material and also releasably retained within the housing 104A. When the spring pre-load is adequately set, this embodiment enables convenient removal of the engraving tool from the housing 104A without the use of additional tools or excessive effort.

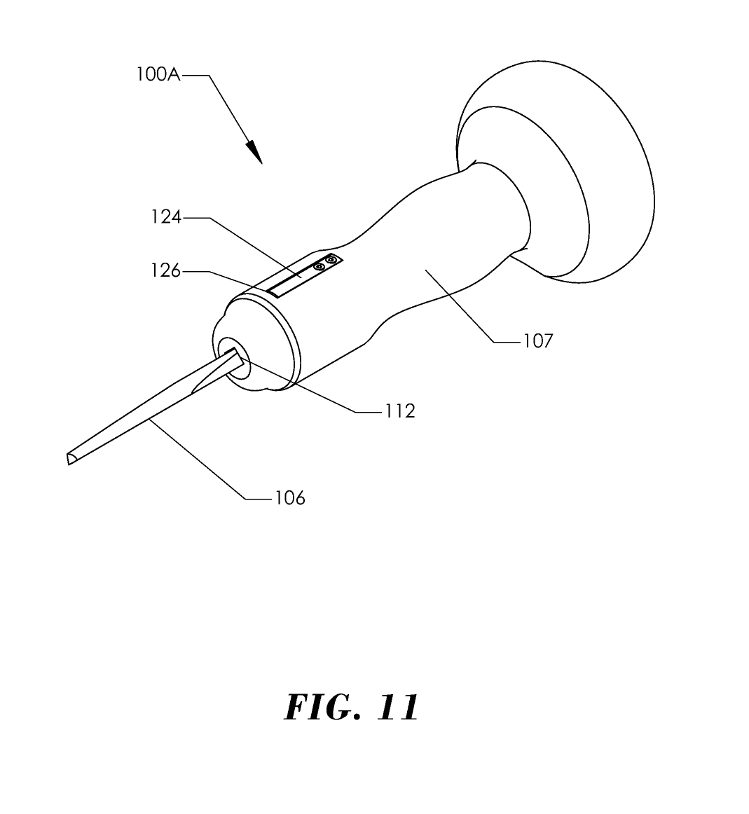

FIG. 11 illustrates an alternate embodiment of the adjustable engraving tool holder 100A of the present invention where the previously described handle 102 and housing 104, as shown in FIG. 2, are combined into a single contoured housing 107 of unitary construction. This embodiment reduces manufacturing complexity and expenses related to producing the engraving tool holder. The functionality of the primary features such as the tool receiving aperture, tool position adjustment bore, adjusting member, retention cavity and retention member remain substantially the same as discussed above with reference to FIGS. 2-9. The contoured housing of unitary construction can be fabricated using any one of several manufacturing techniques such as casting, plastic thermal forming or injection molding. These manufacturing techniques are well-known and therefore are not discussed in detail herein.

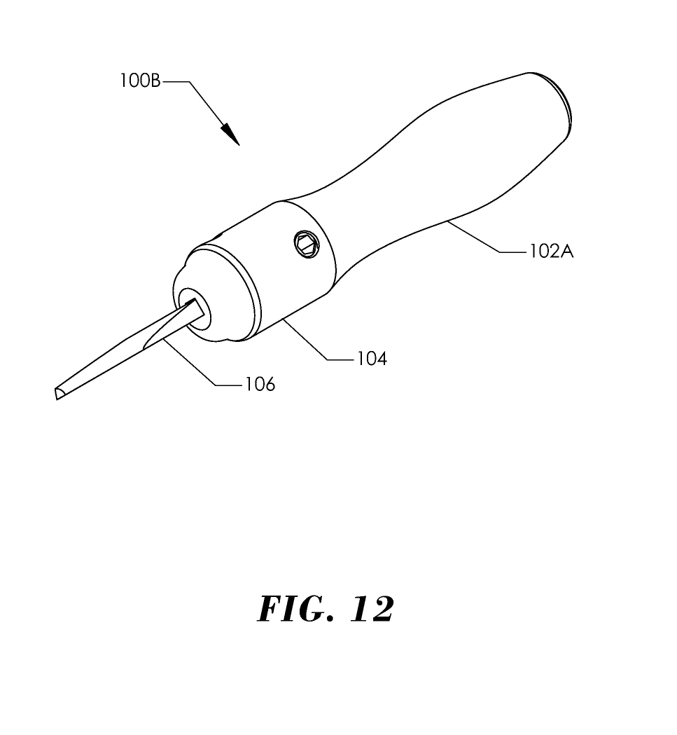

Reference is now made to FIG. 12 which illustrates an isometric view of an alternate embodiment for an adjustable engraving tool holder 100B including an engraving tool 106 as viewed from above. An engraving tool holder housing 104 is shown with a handle 102A mounted thereon. The adjustable engraving tool holder 100B has a handle 102A contoured for use with a chasing hammer. In this embodiment, the handle 102A is elongated so that the end opposite the engraving tool 106 is suitably shaped for striking with a chasing hammer. It is contemplated that this alternate embodiment may also be fabricated as a unitary construction combining the handle 102A and housing 104, in which the adjustable tool holder 100B is contoured for use with a chasing hammer.

The adjustable engraving tool holder invention disclosed herein, provides several advantages not found in known engraving tool holders. Firstly, the invention enables the use of substantially shortened engraving tools. Consequently, an engraver can use an engraving tool for a prolonged period and extract additional value from the engraving tool. Secondly, the invention provides for very fine insertion depth adjustments by way of the axial adjustment bore and adjusting member combination. Thirdly, the invention provides a bearing surface and means for releasably retaining the engraving tool so that the engraving tool does not become loose during repetitive cutting motions. Finally, the invention enables convenient removal of the engraving tool for sharpening and further provides for accurately reinstalling the engraving tool without the use of additional tools, excessive effort or a secondary device (such as a collet).

Although the above provides a full and complete disclosure of the preferred embodiments of the invention, various modifications, alternate constructions and equivalents will occur to those skilled in the art. For example, an engraving tool receiving aperture may have a cross-sectional contour that is round, triangular or other geometric shape. Therefore, the disclosure should not be construed as limiting the invention, which is defined by the claims.

I claim:

1. An engraving tool holder comprising:
a housing having a forward end, an aft end, a tool receiving aperture extending substantially axial from said forward end toward said aft end, a tool position adjustment bore arranged substantially co-axial with respect to said receiving aperture and extending from said aft end toward said forward end, and a first retention cavity having an axis extending radially outward from said tool receiving aperture, said retention cavity being located adjacent to said forward end;
a tool position adjusting member operatively received in said tool position adjustment bore and arranged for substantially axial motion therealong; and
a tool retention member operatively received in said retention cavity and arranged for substantially radial motion therein.

2. The engraving tool holder of claim 1, wherein said adjustment bore extends axially about ⅔ the length of said housing from said aft end; and
said receiving aperture extends axially about ⅓ the length of said housing from said forward end.

3. The engraving tool holder of claim 1, wherein said retention cavity extends substantially perpendicular to said tool receiving aperture.

4. The engraving tool holder of claim 1, further comprising an additional retention cavity having an axis extending radially outward from said receiving aperture, said additional retention cavity being located adjacent to said forward end.

5. The engraving tool holder of claim 4, wherein said additional retention cavity is offset towards the aft end with respect to said first retention cavity.

6. The engraving tool holder of claim 4, wherein said additional retention cavity is angularly offset with respect to said first retention cavity and aligned along said receiving aperture.

7. The engraving tool holder of claim 4, wherein said additional retention cavity is offset towards the aft end and angularly offset with respect to said first retention cavity, and said additional retention cavity being aligned along said receiving aperture.

8. The engraving tool holder of claim 1, wherein said receiving aperture is formed to substantially match an engraving tool cross-section.

9. The engraving tool holder of claim 1, wherein said receiving aperture is substantially square.

10. The engraving tool holder of claim 1, further comprising a handle having an axial cavity is adapted for receiving a portion of the aft end of said housing, and said housing is adapted for insertion within said axial cavity.

11. The engraving tool holder of claim 1, wherein said housing includes a handle integrally formed adjacent said aft end.

12. The engraving tool holder of claim 1, wherein said adjustment bore has internal threads formed therein, and said adjusting member has mating external threads formed thereon.

13. The engraving tool holder of claim 1, wherein said adjustment bore has an indexing surfaced internally formed therein, and said adjusting member has a spring-loaded protrusion for engaging said indexing surface.

14. The engraving tool holder of claim 1, wherein said retention cavity has internal threads formed therein, and said retention member has mating external threads formed thereon.

15. The engraving tool holder of claim 14, wherein said retention member is a ball plunger.

16. The engraving tool holder of claim 1, wherein said retention cavity is formed to substantially match a profile of a spring-bar, and said spring-bar is adapted for insertion into said retention cavity.

17. A method of fabricating an adjustable engraving tool holder, the method comprising the steps of:
(a) fabricating a housing having a forward end and an aft end;
(b) forming a substantially axial aligned tool receiving aperture in the housing extending rearwardly from the forward end of the housing;
(c) forming a substantially axial aligned tool position adjustment bore in the housing extending forwardly from the aft end of the housing; and
(d) forming a radially extending retention cavity in the housing adjacent to the forward end of the housing and terminating in and substantially perpendicular with the receiving aperture.

18. The method of claim 17, further comprising a step of providing an adjusting member for operative insertion into the adjustment bore; and a step of providing a retention member for operative insertion into the retention cavity.

19. The method of claim 17, further comprising a step of providing a handle having an axial cavity formed therein, and a step of fabricating the housing which is adapted for insertion within the axial cavity.

20. The method of claim 17, further comprising a step of providing internal threads formed on the adjustment bore, and a step of providing an adjusting member having mating external threads formed thereon.
